(19) United States
(12) Patent Application Publication
(10) Pub. No.: US 2025/0279612 A1
(43) Pub. Date: Sep. 4, 2025

(54) LEVER-TYPE CONNECTOR

(71) Applicant: SUMITOMO WIRING SYSTEMS, LTD., Mie (JP)

(72) Inventors: Yuki HORIGUCHI, Mie (JP); Ryousuke GIGA, Mie (JP)

(21) Appl. No.: 18/859,169

(22) PCT Filed: Apr. 13, 2023
(86) PCT No.: PCT/JP2023/014997

§ 371 Date: Oct. 23, 2024

(30) Foreign Application Priority Data
Apr. 27, 2022 (JP) 2022-073117

(51) Int. Cl. H01R 13/629

(52) U.S. Cl. CPC H01R 13/6295; H01R 13/62955; H01R 13/62944

(57) ABSTRACT

In a lever-type connector 10, a lever 30 includes an arm portion 32 to be disposed along a side surface of a connector housing 20 and a connection detecting member 51 mounted on the arm portion 32 and displaceable between a standby position and a detection position. The arm portion 32 and the connection detecting member 51 include movement restricting portions 37, 67 for restricting the connection detecting member 51 in an inclined posture from being displaced toward the standby position by locking each other if the connection detecting member 51 is set in the inclined posture by applying a force to the arm portion 32 in a direction to release connection and for allowing a displacement of the connection detecting member 51 if the connection detecting member 51 is set in the proper posture.

### TECHNICAL FIELD

The present disclosure relates to a lever-type connector.

### BACKGROUND

A lever-type connector is provided with a lever for assisting connection to and separation from a mating connector by the principle of leverage. In connecting the lever-type connector to the mating connector, the both connectors can be easily connected with a small force by cam action between a cam groove and a cam follower according to the rotation of the lever from an initial position to a proper connection position after housings are opposed to each other and initially fit.

The connector as described above may be provided with a detecting member for detecting a state where the lever has not reached the connection position and the housing has not been properly connected to the mating housing yet (incompletely connected state). The detecting member stays at a standby position in the incompletely connected state of the lever, and is displaceable to a detection position when the lever reaches the connection position. That is, whether or not the lever has reached the connected state can be judged by displacing the detecting member.

### PRIOR ART DOCUMENT

### Patent Document

Patent Document 1: JP 2003-133001 A

### SUMMARY OF THE INVENTION

### Problems to be Solved

For example, in Patent Document 1, if a force is applied to the lever in a direction to release connection with the lever set at a connection position and a detecting member arranged at a connection detection position, a component of force may act on the detecting member in a direction to displace the detecting member from a detection position to a standby position and the detecting member may be displaced to the standby position.

### Means to Solve the Problem

The present disclosure is directed to a lever-type connector with a connector housing connectable to a mating connector, and a lever rotatable from a connection start position to a connection completion position about a rotary shaft provided on a side surface of the connector housing, the lever including an arm portion to be disposed along the side surface of the connector housing and a connection detecting member mounted on the arm portion, the connection detecting member being allowed to be displaced from a standby position to a detection position when the lever reaches the connection completion position and being restricted from being displaced from the standby position to the detection position when the lever is at an incomplete connection position without reaching the connection completion position, and the arm portion and the connection detecting member being provided with movement restricting portions for restricting the connection detecting member in an inclined posture from being displaced toward the standby position by locking each other if the connection detecting member is set in the inclined posture inclined from a proper posture with respect to the arm portion by applying a force to the arm portion in a direction to release connection with the connection detecting member disposed at the detection position and for allowing a displacement of the connection detecting member if the connection detecting member is set in the proper posture.

### Effect of the Invention

According to the lever-type connector of the present disclosure, even if a force is applied to the lever in a direction to release connection with the connection detecting member arranged at the detection position, the connection detecting member can be displaced from the detection position to the standby position and the connection release of the connector can be suppressed.

### BRIEF DESCRIPTION OF THE DRAWINGS

FIG. 1 is a side view of a lever-type connector of a first embodiment (a lever is at a connection start position).

FIG. 2 is a side view of the lever-type connector of the first embodiment (the lever is at a connection completion position and a connection detecting member is at a standby position).

FIG. 3 is a section along I-I of FIG. 2.

FIG. 4 is a side view of the lever-type connector of the first embodiment (the lever is at the connection completion position and the connection detecting member is at a detection position).

FIG. 5 is a section along II-II of FIG. 4.

FIG. 6 is a partial enlarged side view of FIG. 4.

FIG. 7 is a section along III-III of FIG. 6.

FIG. 8 is a partial enlarged side view when the connection detecting member of the first embodiment is set in an inclined posture.

FIG. 9 is a section along IV-IV of FIG. 8.

FIG. 10 is a perspective view of a lever body of the first embodiment.

FIG. 11 is a perspective view of the connection detecting member of the first embodiment.

FIG. 12 is a side view of a lever-type connector of a second embodiment (a lever is at a connection start position).

FIG. 13 is a side view of the lever-type connector of the second embodiment (the lever is at a connection completion position and a connection detecting member is at a standby position).

FIG. 14 is a section along V-V of FIG. 13.

FIG. 15 is a side view of the lever-type connector of the second embodiment (the lever is at the connection completion position and the connection detecting member is at a detection position).

FIG. 16 is a section along VI-VI of FIG. 15.

FIG. 17 is a partial enlarged side view of FIG. 15.

FIG. 18 is a section along VII-VII of FIG. 17.

FIG. 19 is a partial enlarged side view when the connection detecting member of the second embodiment is set in an inclined posture.

FIG. 20 is a section along VIII-VIII of FIG. 19.

FIG. 21 is a perspective view of a lever body of the second embodiment.

FIG. 22 is a perspective view of the connection detecting member of the second embodiment.

### DETAILED DESCRIPTION TO EXECUTE THE INVENTION

### Summary of Embodiments

First, embodiments of the present disclosure are listed and described.

(1) The lever-type connector of the present disclosure is provided with a connector housing connectable to a mating connector, and a lever rotatable from a connection start position to a connection completion position about a rotary shaft provided on a side surface of the connector housing, the lever including an arm portion to be disposed along the side surface of the connector housing and a connection detecting member mounted on the arm portion, the connection detecting member being allowed to be displaced from a standby position to a detection position when the lever reaches the connection completion position and being restricted from being displaced from the standby position to the detection position when the lever is at an incomplete connection position without reaching the connection completion position, and the arm portion and the connection detecting member being provided with movement restricting portions for restricting the connection detecting member in an inclined posture from being displaced toward the standby position by locking each other if the connection detecting member is set in the inclined posture inclined from a proper posture with respect to the arm portion by applying a force to the arm portion in a direction to release connection with the connection detecting member disposed at the detection position and for allowing a displacement of the connection detecting member if the connection detecting member is set in the proper posture.

According to the above configuration, a displacement of the connection detecting member at the detection position to the standby position is restricted by the movement restricting portions even if a force is applied to the lever in a connected state in a direction to unintentionally release the connection. Therefore, the connection release of the connector can be suppressed.

(2) The arm portion may be provided with a window portion penetrating through the arm portion, the connection detecting member may include a body portion disposed along the connector housing and a projecting portion disposed in the window portion by projecting to rise from a plate surface of the body portion, the projecting portion being displaceable between the standby position and the detection position in the window portion, a locking portion projecting in a direction intersecting a displacement direction of the projecting portion may be provided on a connection completion side wall surface disposed at the connection completion position side, out of an inner peripheral surface of the window portion, and the connection detecting member in the inclined posture may be restricted from being displaced toward the standby position by a part of the projecting portion being locked to the locking portion.

By this configuration, it is possible to provide a specific mode of restricting a displacement of the connection detecting member in the inclined posture to the standby position if a force is applied to the lever in the connected state in a direction to release the connection.

(3) The locking portion may be ridge-like and provided in a region corresponding to the projecting portion disposed at the detection position, out of the connection completion side wall surface of the window portion, the projecting portion may be provided with a concave locking recess capable of receiving the locking portion when the connection detecting member is set in the inclined posture, and the connection detecting member in the inclined posture may be restricted from being displaced toward the standby position by the locking portion being locked into the locking recess.

(4) A cut portion capable of receiving a part of the projecting portion in the inclined posture by being recessed from the connection completion side wall surface may be provided in a region corresponding to the projecting portion disposed at the detection position, out of the connection completion side wall surface of the window portion, and the connection detecting member in the inclined posture may be restricted from being displaced toward the standby position by a part of the projecting portion being locked to an opening edge part of the cut portion.

(5) An arcuate portion projecting while having an arcuate shape centered on the rotary shaft and capable of holding the connection detecting member at the standby position in a rotation process of the lever and a concave escape recess connected to the arcuate portion and allowing the connection detecting member of the lever disposed at the connection completion position to displaceably escape to the detection position may be formed on the side surface of the connector housing.

By this configuration, it is possible to provide a specific mode of holding the connection detecting member at the standby position in the rotation process and enabling a displacement to the detection position when the connection is completed.

### Details of Embodiments of Present Disclosure

Specific examples of a lever-type connector of the present disclosure are described below with reference to the drawings. Note that the present disclosure is not limited to these illustrations, but is represented by claims and intended to include all changes in the scope of claims and in the meaning and scope of equivalents.

### First Embodiment

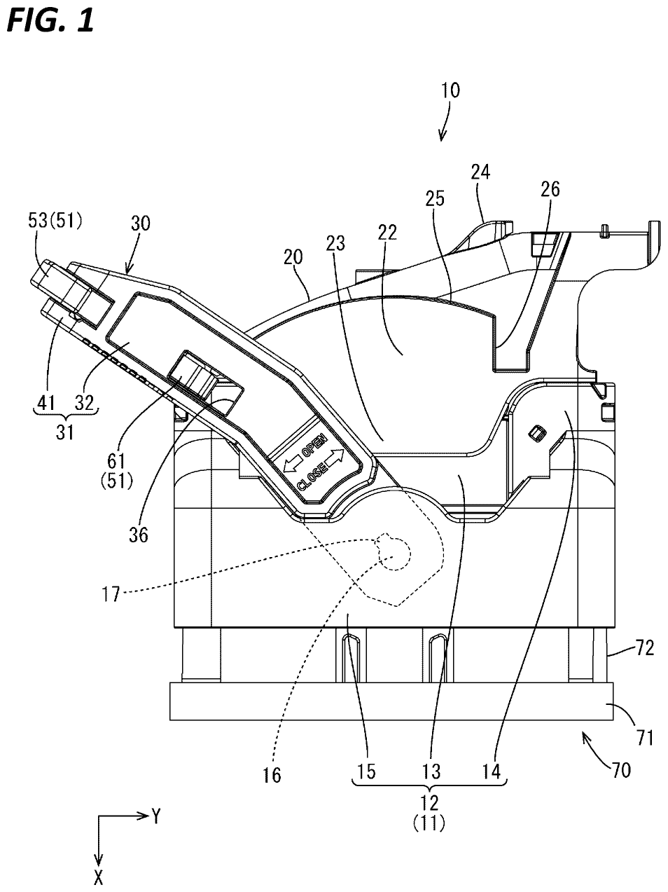

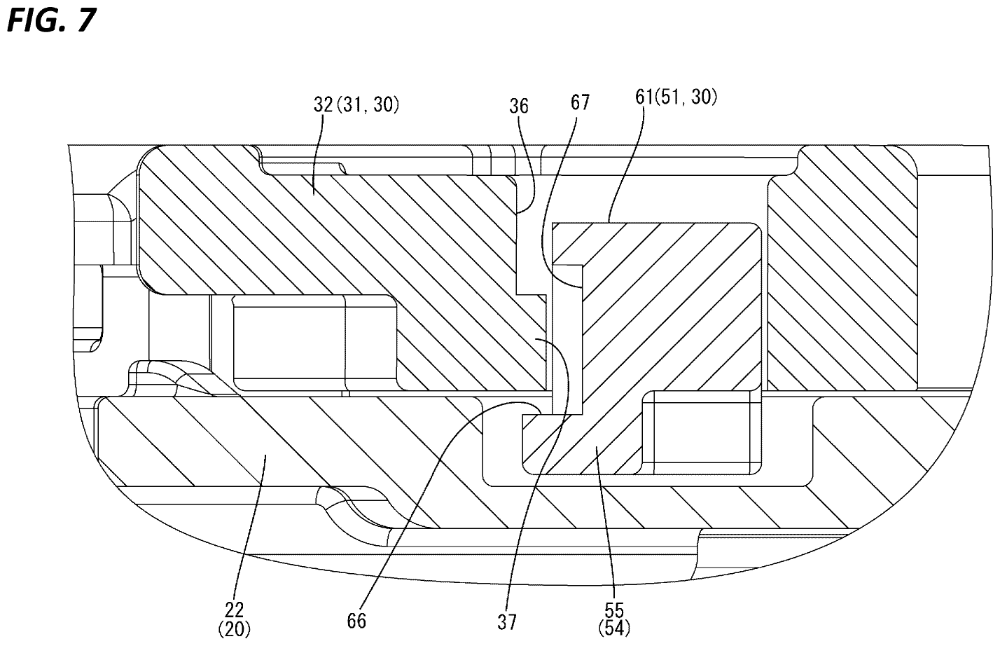

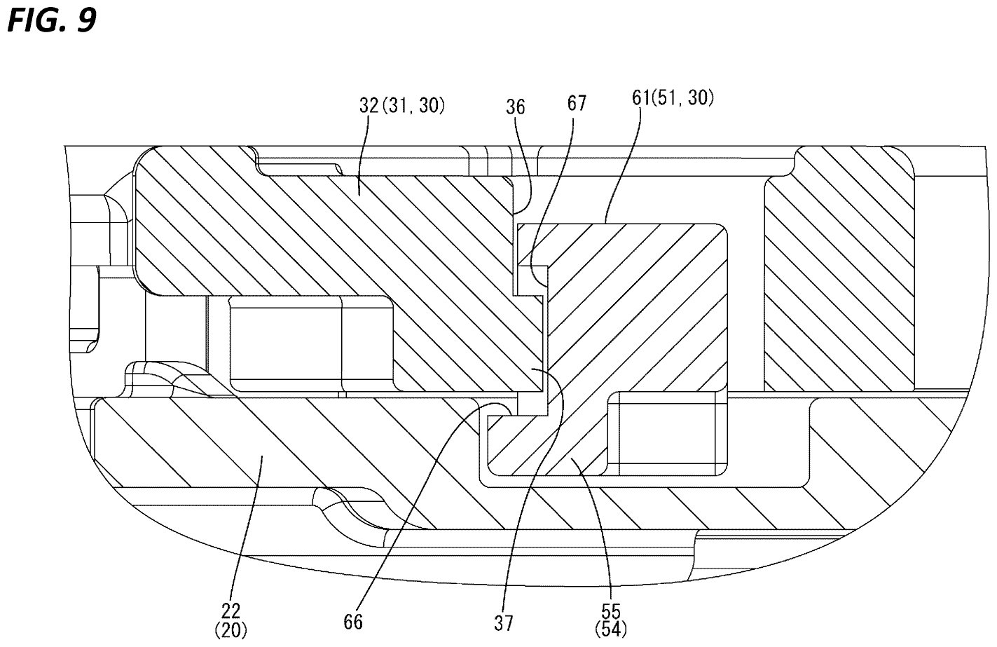

A first embodiment is described with reference to FIGS. 1 to 11. In the following description, a connection direction (X direction) to a mating connector is a forward direction and an opposite direction thereof is a rearward direction. Further, a Y direction is a rightward direction, and an opposite direction thereof is a leftward direction. Further, concerning a lever, a connection advance direction (rightward direction of FIG. 1) in a rotation direction is a connection completion direction, and an opposite direction thereof (leftward direction of FIG. 1) is a connection start direction. Further, for convenience, female terminals and wires are not shown.

A lever-type connector of this embodiment is a female connector 10 to be connected to a male connector (an example of a mating connector). The female connector 10 is provided with a housing body (an example of a connector housing) 11 for holding the female terminals connected to ends of the wires, a wire cover (an example of the connector housing) 20 to be assembled with the housing body 11 and a lever 30 to be likewise assembled with the housing body 11.

### [Housing Body 11]

The housing body 11 is made of synthetic resin and configured such that an inner housing for holding the female terminals is held inside an outer housing 12. The inner housing is substantially in the form of a rectangular block and includes a plurality of cavities penetrating in the front-rear direction, and the female terminal and an end part of the wire connected to the female terminal can be accommodated in each cavity.

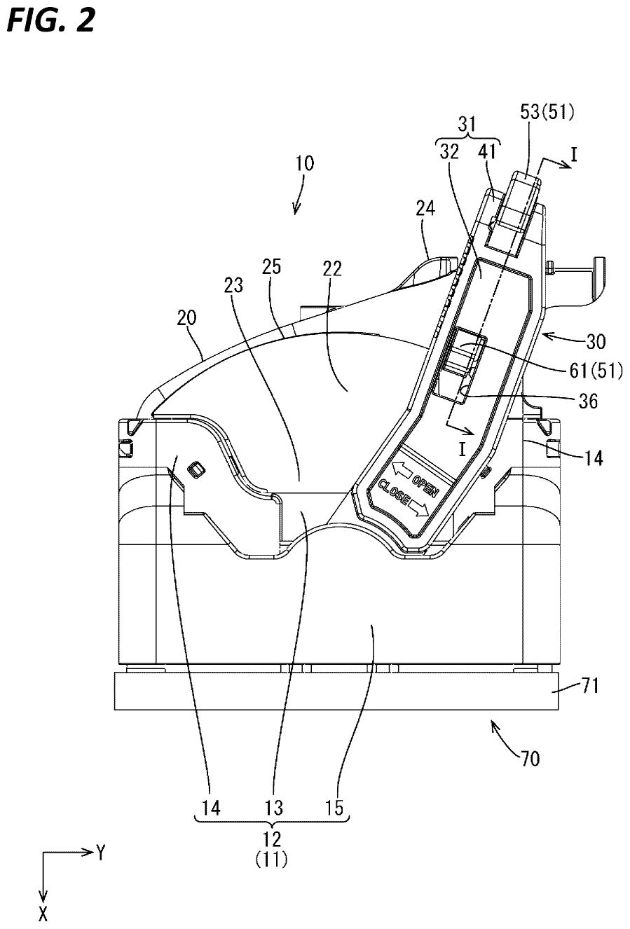

The outer housing 12 is substantially in the form of a rectangular tube as a whole. As shown in FIGS. 1 and 2, the outer housing 12 is provided with an inner holding wall 13, two cover holding walls 14, two lever holding walls 15 and two rotary shafts 16. The inner holding wall 13 is substantially in the form of a rectangular tube and can hold the aforementioned inner housing inside.

The two cover holding walls 14 extend in the front-rear direction while having a U-shaped cross-section when viewed from behind, and are arranged to face each other. As shown in FIGS. 1, 2 and the like, the cover holding walls 14 are overlapped on the outer periphery of the inner holding wall 13 to surround wall portions on short sides of the inner holding wall 13 facing each other, and extend further rearward (upward in FIG. 1) from the rear end of the inner holding wall 13. Locked portions for locking the wire cover 20 are provided on these extending parts.

The two lever holding walls 15 are arranged apart from the outer periphery of the inner holding wall 13 via spaces on front end sides (lower sides of FIG. 1) of wall portions on long sides of the inner holding wall 13 facing each other. Both end parts in the front-rear direction of each lever holding wall 15 are coupled to the cover holding walls 14. In this way, a space open in the front-rear direction is formed between the lever holding wall 15 and the inner holding wall 13. This space serves as a lever accommodating portion for allowing the entrance of a part of an arm portion 32 of the lever 30 to be described later.

The two rotary shafts 16 are provided to project toward the inner holding wall 13 from the inner surfaces of the lever holding walls 15 in the lever accommodating portions. The rotary shaft 16 has a cylindrical shape for rotatably supporting the lever 30.

### [Wire Cover 20]

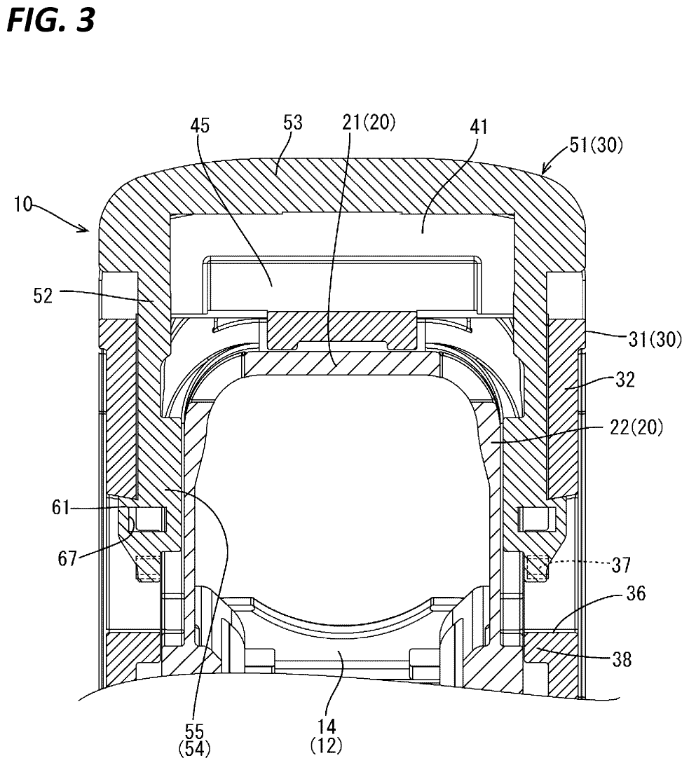

The wire cover 20 is a member to be assembled with the housing body 11 to cover a back surface for protecting the wires drawn out from the inner housing and leading out the wires in a predetermined direction. The wire cover 20 is made of synthetic resin and has a substantially box shape with open front and right sides. It is assumed below that a wall extending in a lateral direction to cover the back surface of the housing body 11 is a main wall 21 (see FIG. 3) and two walls extending forward from side edge parts of the main wall 21 and disposed to face each other are side walls 22. One end side (left side) of the main wall 21 is curved forward and connected to a left edge part of the side wall 22.

An extended wall portion 23 extending forward is provided on the front end of a central part of the side wall 22 in a longitudinal direction (lateral direction, Y direction). As shown in FIGS. 1 and 2, the extended wall portion 23 has a tapered trapezoidal shape. With the wire cover 20 assembled with the housing body 11, the extended wall portion 23 is arranged on the outer periphery of the inner holding wall 13.

The main wall 21 of the wire cover 20 is provided with a cantilevered resilient locking piece 24 projecting rearward. The resilient locking piece 24 is formed by cutting and raising the main wall 21 into a U shape from left to right, and is resiliently deformable in a direction intersecting a plate surface of the main wall 21. A right end part of the resilient locking piece 24 comes into contact with a rotating portion 41 of the lever 30 from left at a connection completion position (see FIG. 2), whereby the lever 30 is restricted from rotating from the connection completion position to a connection start position.

The wire cover 20 is provided with locking projections provided to project outward on the right front end and of the main wall 21 and the left front ends of the side walls 22. By fitting these locking projections into the respective locked portions provided in the cover holding walls 14, the wire cover 20 is fixed to the housing body 11.

### [Lever 30]

The lever 30 is a member for assisting the connection and separation of the female connector 10 and a male connector 70. The lever 30 is made of synthetic resin and, as shown in FIGS. 1, 2 and the like, provided with a lever body 31 to be rotatably assembled with the housing body 11 (outer housing 12) and a connection detecting member 51 to be assembled with the lever body 31 for conforming the connection completion of the housing body 11 to the male connector 70.

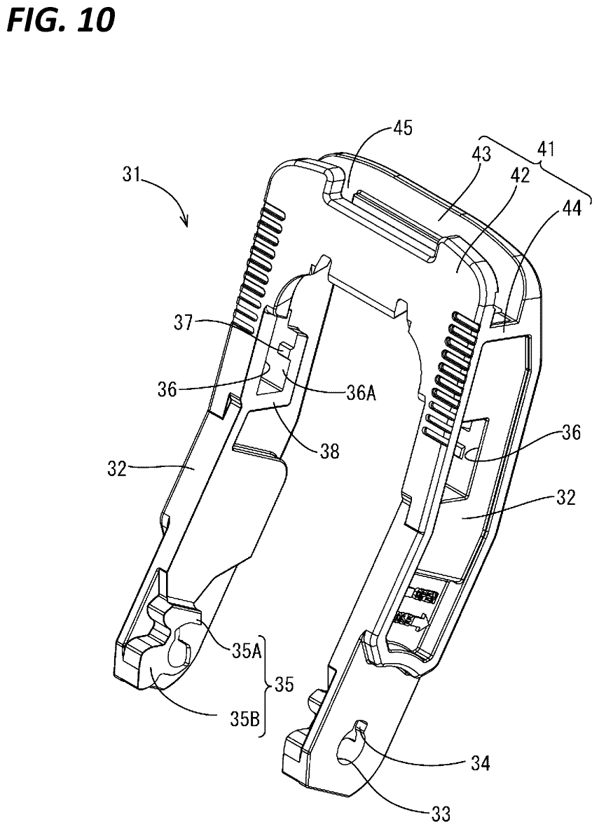

As shown in FIG. 10, the lever body 31 includes two arm portions 32 and the rotating portion 41 coupling one end sides of the two arm portions 32. The two arm portions 32 are each in the form of an elongated plate, arranged on both outer sides of the inner holding wall 13 and facing each other (see FIGS. 1 and 3). A tip part (end part opposite to the rotating portion 41) of each of the two arm portion 32 is accommodated into each of the two lever accommodating portions and arranged along each of the two lever holding walls 15. As shown in FIG. 10, each arm portion 32 includes a shaft hole 33 for receiving the rotary shaft 16, a gear portion 35 disposed around the shaft hole 33, a window portion 36 for accommodating the connection detecting member 51 and a slide guiding portion 38 for sliding the connection detecting member 51.

The shaft hole 33 is a circular hole disposed in the tip part of the arm portion 32. A passage recess 34 communicating with the shaft hole 33 and allowing the passage of a retaining projection 17 (see FIG. 1) provided on the tip of the rotary shaft 16 is disposed on a peripheral edge part of the shaft hole 33. The gear portion 35 is disposed on the inner surface of the arm portion 32 facing the inner holding wall 13 and includes a first gear tooth 35A and a second gear tooth 35B extending to surround the shaft hole 33. The first and second gear teeth 35A, 35B are arranged at an interval.

The window portion 36 is a through hole arranged at a position closer to the rotating portion 41 than the shaft hole 33 in the arm portion 32. The window portion 36 has a rectangular shape and is arranged in such an orientation that a longitudinal direction coincides with an extension direction of the arm portion 32.

The slide guiding portion 38 rises into a U shape along a hole edge part of the window portion 36 except on the side of the rotating portion 41 on the inner surface (surface facing the opposite arm portion 32) of the arm portion 32, and constitutes a groove-like part extending in the extension direction (substantially vertical direction of FIG. 10) of the arm portion 32. The inner wall surfaces of groove walls (wall portions disposed to face each other) constituted by the slide guiding portions 38 are continuous and flush with the inner peripheral surfaces of the window portions 36. The inner wall surface of the slide guiding portion 38 is described to be included in the inner peripheral surface of the window portion 36 below.

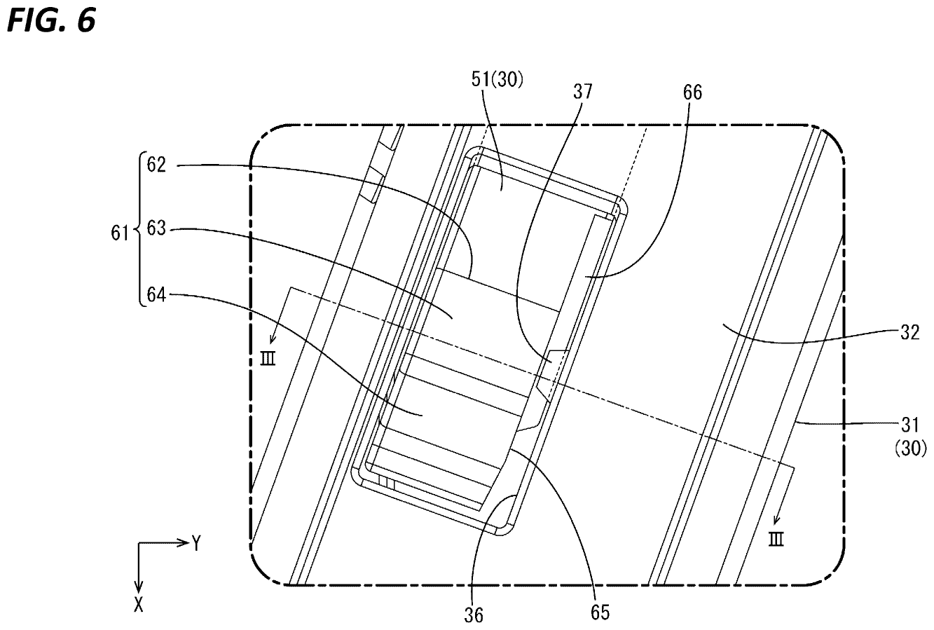

Out of the inner peripheral surface of the window portion 36, a wall surface (connection completion side wall surface 36A) arranged on the connection completion position side (right side of FIG. 2) is provided with a rectangular ridge portion 37 projecting inward of the window portion 36 (see FIGS. 6 and 10). In this embodiment, the ridge portion 37 is provided at a position continuous and flush with the inner surface (surface on the side of the slide guiding portion 38) of the arm portion 32 substantially in a central part in the longitudinal direction of the window portion 36 (see FIG. 10). That is, the ridge portion 37 projects from the inner wall surface of the slide guiding portion 38.

As shown in FIG. 10, the rotating portion 41 includes a first bridge portion 42 and a second bridge portion 43 linking end parts of the two arm portions 32 and a third bridge portion 44 linking the first and second bridge portions 43, 44 at a middle position between the two arm portions 32. A space defined by the three bridge portions 42, 43 and 44 serves as a detecting member accommodating portion 45 for accommodating a later-described push-in portion 53 of the connection detecting member 51.

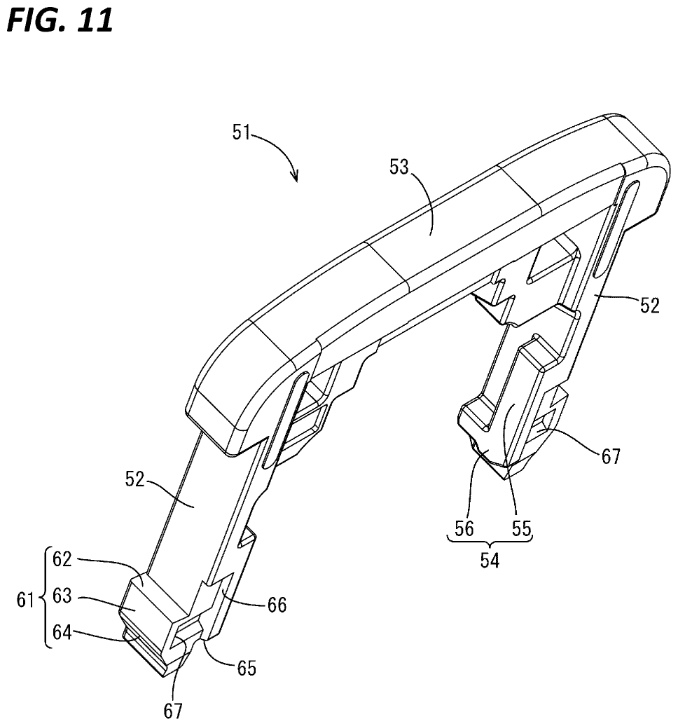

As shown in FIG. 11, the connection detecting member 51 includes two detecting member side arm portions 52 (an example of a body portion) arranged along side surfaces of the wire cover 20 while facing each other, the push-in portion 53 coupling one end parts of the two detecting member side arm portions 52, and guide portions 54 and projecting portions 61 respectively projecting from the two detecting member side arm portions 52. A width of the detecting member side arm portion 52 is substantially equal to that of the aforementioned window portion 36 as a whole.

The guide portion 54 is an L-shaped projection located near a tip side opposite to the push-in portion 53 on the detecting member side arm portion 52 and projecting from an inner surface facing the opposite detecting member side arm portion 52. In particular, the guide portion 54 is composed of a guide portion body 55 extending along an extension direction of the detecting member side arm portion 52 on an edge part on a connection completion direction side (right side of FIG. 2) of the detecting member side arm portion 52 and a contact portion 56 extending from a tip side (side opposite to the push-in portion 53) of the guide portion body 55 toward an edge part on a connection start direction side (left side of FIG. 2).

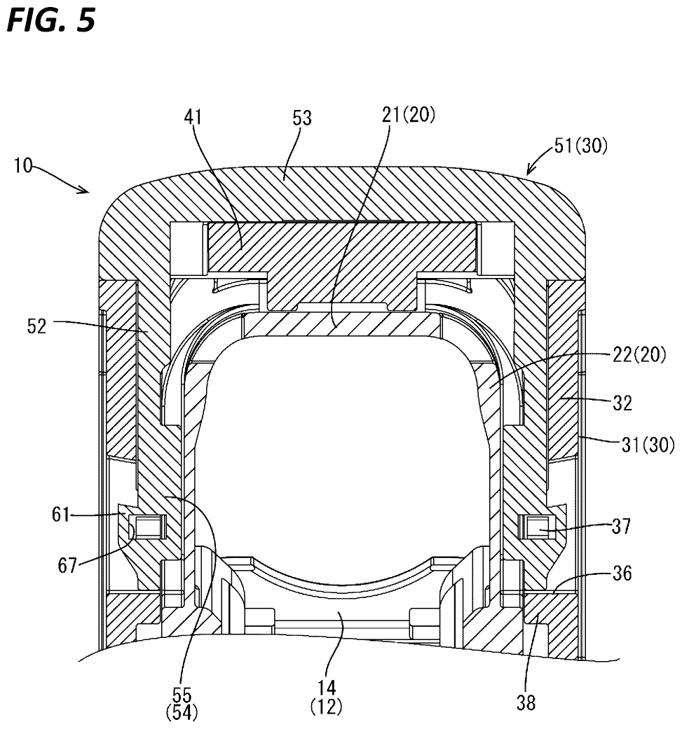

The guide portion 54 is so set that the inner surface thereof is located further inward than the inner surface of the slide guiding portion 38 with the connection detecting member 51 assembled with the lever body 31 (see FIGS. 3 and 5).

The projecting portion 61 is a projection located adjacent to the tip of the detecting member side arm portion 52 and projecting to rise from a plate surface from an outer surface opposite to the inner surface on the detecting member side arm portion 52. In particular, the projecting portion 61 includes a rising portion 62 rising perpendicularly outward from the plate surface of the detecting member side arm portion 52, a parallel portion 63 extending in parallel to the plate surface of the detecting member side arm portion 52 from the tip of the rising portion 62 toward the tip side of the detecting member side arm portion 52 and an inclined portion 64 inclined in a direction approaching the plate surface of the detecting member side arm portion 52 from the parallel portion 63 to the tip side of the detecting member side arm portion 52, and has a trapezoidal side view shape.

The projecting portion 61 includes a hollow portion surrounded by these rising portion 62, parallel portion 62 and inclined portion 64 and the guide portion body 55. This hollow portion serves as a locking recess 67 of a size to be able to receive the aforementioned ridge portion 37 by being concavely recessed from a surface of the detecting member side arm portion 52 on the connection completion side.

Out of a pair of side edge parts of the projecting portion 61, the side edge part on a right side (connection completion position side) of FIG. 2 is provided with a cut portion 65 cut along the side edge part from the tip of the detecting member side arm portion 52 as shown in FIGS. 6 and 11. That is, a width of the tip part of the detecting member side arm portion 52 is made somewhat smaller than that of the window portion 36 by this cut portion 65, and a clearance is present between the tip part of the detecting member side arm portion 52 and the inner peripheral wall of the window portion 36. This cut portion 65 extends from the tip of the detecting member side arm portion 52 to a position adjacent to the parallel portion 63 of the projecting portion 61.

Further, the outer surface of the detecting member side arm portion 52 is continuously cut along the side edge part from an end part of the cut portion 65 on the side of the push-in portion 53 to form a rail portion 66. That is, the rail portion 66 is a thin plate-like part extending along the side edge part on the inner surface side of the detecting member side arm portion 52. By moving the aforementioned ridge portion 37 along this rail portion 66, a smooth displacement of the connection detecting member 51 can be guided.

As shown in FIGS. 3 and 5, the lever body 31 and the connection detecting member 51 are assembled such that the push-in portion 53 and parts of the detecting member side arm portions 52 of the connection detecting member 51 can be accommodated in the detecting member accommodating portion 45 of the lever body 31 and the two detecting member side arm portions 52 of the connection detecting member 51 are respectively slidably accommodated in the two slide guiding portions 38 of the lever body 31. In this state, the guide portions 54 of the connection detecting member 51 are set to project from the inner surfaces of the arm portions 32 (slide guiding portions 38) of the lever body 31 (see FIGS. 3 and 5). Further, the two projecting portions 61 respectively project into the two window portions 36. A projecting direction of the projecting portion 61 coincides with a penetrating direction of the window portion 36.

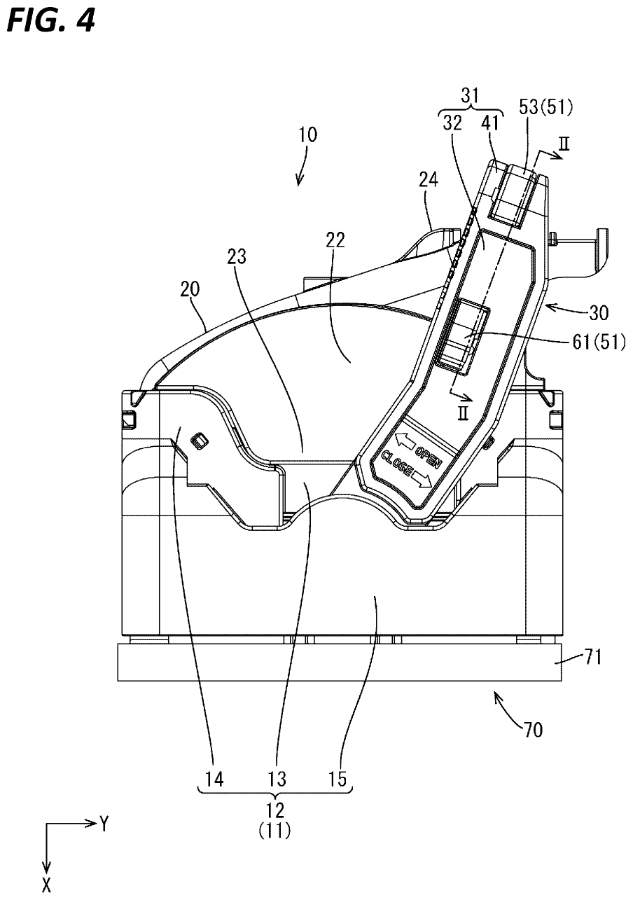

The connection detecting member 51 is displaceable between a standby position (position shown in FIGS. 2 and 3) where a part of the push-in portion 53 projects from the rotating portion 41 and a detection position (position shown in FIGS. 4 and 5) where the push-in portion 53 is entirely accommodated in the detecting member accommodating portion 45 and does not project from the rotating portion 41.

Note that, with the connection detecting member 51 set at the standby position, the ridge portions 37 projecting from the inner peripheral walls of the window portions 36 are set to overlap the cut portions 65 of the detecting member side arm portions 52 of the connection detecting member 51.

Further, with the connection detecting member 51 disposed at the detection position, the ridge portions 37 are set to overlap the rail portions 66 of the connection detecting member 51 from outside, whereby outward movements of the projecting portions 61 are restricted (see FIG. 6). Further, at this time, the locking recesses 67 provided in the projecting portions 61 are set to be arranged at positions facing the ridge portions 37.

The two arm portions 32 of the aforementioned lever 30 are respectively accommodated in the two lever accommodating portions of the housing body 11 as shown in FIGS. 1 and 2. Tip sides of the outer surfaces of the arm portions 32 are disposed along the lever holding walls 15. Further, the inner surfaces of the arm portions 32 are disposed along the inner holding wall 13 and the wire cover 20.

The lever 30 is rotatable about the rotary shafts 16 between the connection start position (position shown in FIG. 1) and the connection completion position (position shown in FIG. 2). When being at the connection start position, the lever 30 is arranged to be inclined obliquely leftward with respect to the housing body 11. When being at the connection completion position, the lever 30 is arranged to be inclined obliquely rightward with respect to the housing body 11.

An arcuate portion 25 having an arcuate shape centered on the rotary shaft 16, projecting outward and capable of holding the connection detecting member 51 at the standby position in a rotation process of the lever 30 is provided on the side surface of the wire cover 20. The connection detecting member 51 is so set that the lower ends of the contact portions 56 of the guide portions 54 slide on the arcuate portions 25 during the rotation of the lever 30, whereby the connection detecting member 51 is held at the standby position.

Further, a concave escape recess 26 connected to the arcuate portion 25 for allowing the connection detecting member 51 of the lever 30 disposed at the connection completion position to displaceably escape from the standby position to the detection position is formed to be recessed forward (downward of FIG. 1) in the side surface of the wire cover 20. In this way, the connection detecting member 51 of the lever 30 at the connection completion position is displaceable forward (toward the detection position), whereby the connection completion can be detected. Further, by substantially tightly fitting the connection detecting member 51 into the escape recesses 26, a rotating operation of the lever 30 is hindered.

### [Male Connector 70]

As shown in FIG. 1, the male connector 70 (an example of the mating connector) includes a bottom plate portion 71 and a tubular receptacle 72 extending from the bottom plate portion 71. Male terminals to be connected to the female terminals held in the inner housing are held in the male connector 70.

Note that, although not shown, gear receiving portions corresponding to the gear portions 35 respectively provided on the two arm portions 32 of the lever 30 are provided on the outer surface of the receptacle 72. The male connector 70 and the female connector 10 are connected by cam action of the gear portions 35 and the gear receiving portions caused by the rotating operation of the lever 30.

### [Connection of Female Connector 10 and Male Connector 70]

Next, an example of a procedure of connecting the female connector 10 and the male connector 70 configured as described above is described below. First, as shown in FIG. 1, the housing body 11 of the female connector 10 is lightly connected to the male connector 70 and the tip of the receptacle 72 is inserted into a connection space of the housing body 11 with the lever 30 set at the connection start position.

At this time, the connection detecting member 51 assembled with the lever body 31 is at the standby position where the push-in portion 53 projects upward from the detecting member accommodating portion 45 of the rotating portion 41. Further, the connection detecting member 51 is held at the standby position by placing the contact portions 56 of the guide portions 54 of the detecting member side arm portions 52 on the upper surfaces of the arcuate portions 25.

Subsequently, the lever 30 is rotated from the connection start position (see FIG. 1) to the connection completion position (see FIG. 2). During this rotation, since the contact portions 56 of the guide portions 54 slide on the upper surfaces of the arcuate portions 25, the connection detecting member 51 is held at the standby position. According to the rotation of the lever 30, the housing body 11 is relatively pulled toward the male connector 70 and connection proceeds by unillustrated cam action.

As the connection of the female connector 10 and the male connector 70 proceeds and the lever 30 reaches the connection completion position as shown in FIGS. 2 and 3, the housing body 11 reaches a proper connection position with respect to the male connector 70. The rotating portion 41 of the lever 30 comes into contact with the resilient locking piece 24 of the wire cover 20 and gradually pushes down the resilient locking piece 24 immediately before the lever 30 reaches the connection completion position, and rides over the resilient locking piece 24 at the same time as the connection position is reached. In this way, the resilient locking piece 24 resiliently returns and is locked to a surface of the rotating portion 41 of the lever 30 on a side opposite to the rotation direction. In this way, the rotation of the lever 30 toward an opposite side in the rotation direction is restricted and the lever 30 is locked at the connection position.

Subsequently, the push-in portion 53 of the connection detecting member 51 is pushed into the detecting member accommodating portion 45 of the lever body 31 and the connection detecting member 51 at the standby position is displaced to the detection position (see FIGS. 4 and 5). At this time, the rail portions 66 of the projecting portions 61 arranged in the window portions 36 of the lever body 31 relatively move along the ridge portions 37, whereby a smooth displacement is made from the standby position to the detection position.

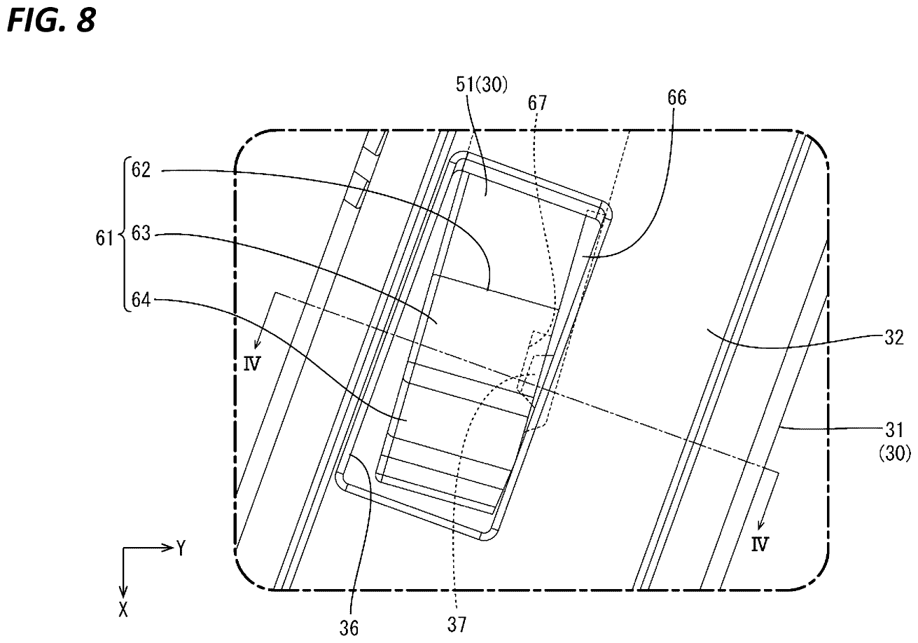

A force may be applied in a direction to release the connection to the lever 30 of the female connector 10 in the connected state where the connection detecting member 51 is disposed at the detection position in this way. If such a force is applied, the posture of the connection detecting member 51 with respect to the lever body 31 may be inclined from a proper posture since the lever body 31 more easily largely moves with respect to the connection detecting member 51 (detecting member side arm portions 52) fit in the escape recesses 26 of the wire cover 20. Specifically, the posture of the projecting portion 61 with respect to the window portion 36 is inclined as shown in FIG. 8.

However, in this embodiment, the ridge portions 37 provided in the window portions 36 are fit into the locking recesses 67 formed in the projecting portions 61 if the posture of the connection detecting member 51 with respect to the lever body 31 is inclined. Accordingly, even if a component of force acts on the connection detecting member 51 in a direction to displace the connection detecting member 51 toward the standby position, a movement of the connection detecting member 51 from the detection position toward the standby position is restricted by locking structures (an example of movement restricting portions) of these ridge portions 37 and the locking recesses 67, whereby unintended connection release is suppressed.

As just described, the lever 30 of this embodiment is configured such that the ridge portions 37 and the locking recesses 67 do not interfere if the connection detecting member 51 is in a proper posture with respect to the lever body 31, and are locked to each other to restrict relative displacements only when the connection detecting member 51 is set in an inclined posture.

Next, functions and effects of this embodiment configured as described above are described. The female connector 10 of this embodiment is provided with the housing body 11 connectable to the male connector 70 and the lever 30 rotatable from the connection start position to the connection completion position about the rotary shafts 16 provided on the side surfaces of the wire cover 20 assembled with the housing body 11. The lever 30 includes the arm portions 32 to be disposed along the side surfaces of the housing body 11 and the connection detecting member 51 mounted on the arm portions 32 and allowed to be displaced from the standby position to the detection position when the lever 30 reaches the connection completion position and restricted from being displacing from the standby position to the detection position when the lever 30 is at an incomplete connection position without reaching the connection completion position. The arm portions 32 and the connection detecting member 51 are provided with the ridge portions 37 and the locking recesses 67 for restricting a displacement of the connection detecting member 51 in an inclined posture toward the standby position by being locked to each other if a force is applied to the arm portions 32 and the connection detecting member 51 is set in the inclined posture inclined from the proper posture with respect to the arm portions 32 with the connection detecting member 51 disposed at the detection position.

According to the above configuration, even if the connection detecting member 51 is set in the inclined posture inclined from the proper posture with respect to the arm portions 32 and a component of force acts on the connection detecting member 51 in a direction to displace the connection detecting member 51 toward the standby position by applying a force to the arm portions 32 in a direction to release the connection with the connection detecting member 51 disposed at the detection position, a displacement of the connection detecting member 51 to the standby position is restricted by the locking structures (movement restricting portions) to the arm portions 32.

Further, the arm portions 32 are provided with the window portions 36 penetrating through the arm portions 32, the connection detecting member 51 includes the detecting member side arm portions 52 to be disposed along the housing body 11 and the projecting portions 61 disposed in the window portions 36 by projecting to rise from the plate surfaces of the detecting member side arm portions 52. The projecting portion 61 is displaceable between the standby position and the detection position in the window portion 36. The ridge portion 37 projecting in the direction intersecting a displacement direction of the projecting portion 61 is provided on the connection completion side wall surface 36A disposed on the connection completion position side, out of the inner peripheral surface of the window portion 36, and the connection detecting member 51 in the inclined posture is restricted from being displaced toward the standby position by parts of the projecting portions 61 being locked to the ridge portions 37.

Furthermore, the ridge portion 37 is provided in a region corresponding to the projecting portion 61 disposed at the detection position, out of the connection completion side wall surface 36A of the window portion 36, the projecting portion 61 is provided with the concave locking recess 67 capable of receiving the ridge portion 37 when the connection detecting member 51 is set in the inclined posture, and the connection detecting member 51 in the inclined posture is restricted from being displaced toward the standby position by the ridge portions 37 being locked into the locking recesses 67.

By this configuration, a displacement of the connection detecting member 51 in the inclined posture toward the standby position can be specifically suppressed.

Further, the side surface of the wire cover 20 is formed with the arcuate portion 25 projecting while having an arcuate shape centered on the rotary shaft 16 and capable of holding the connection detecting member 51 at the standby position in the rotation process of the lever 30 and the concave escape recess 26 connected to the arcuate portions 25 and allowing the connection detecting member 51 of the lever 30 disposed at the connection completion position to displaceably escape to the detection position.

By this configuration, the connection detecting member 51 of the lever 30 being rotated can be held at the standby position, and the connection detecting member 51 of the lever 30 disposed at the connection completion position can be made movable to the detection position and held at the detection position.

### Second Embodiment

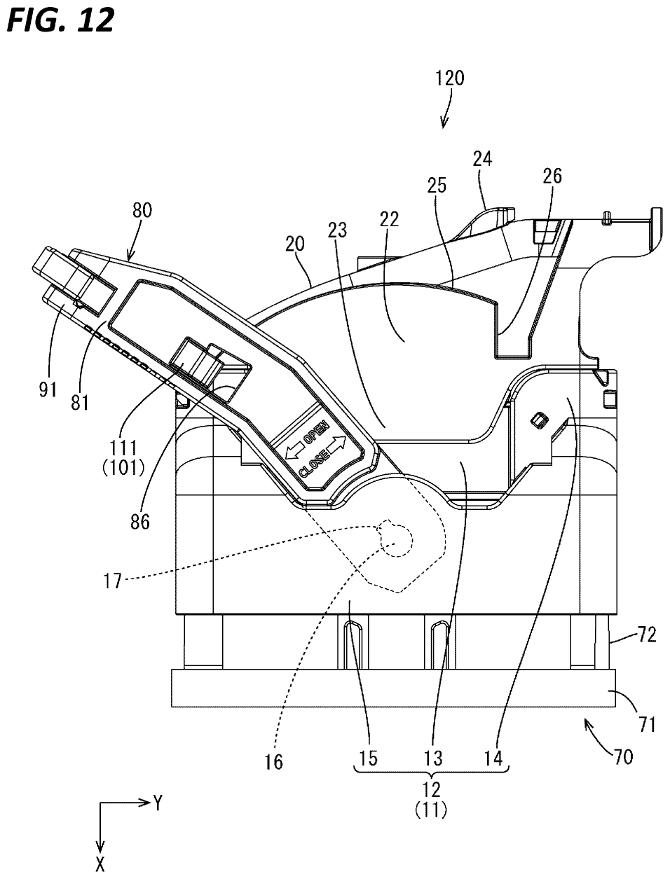

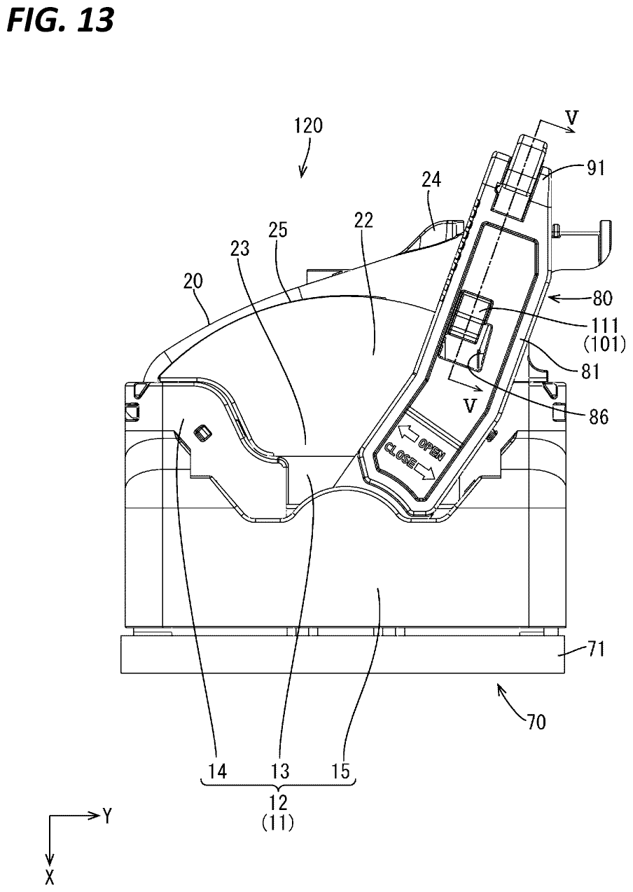

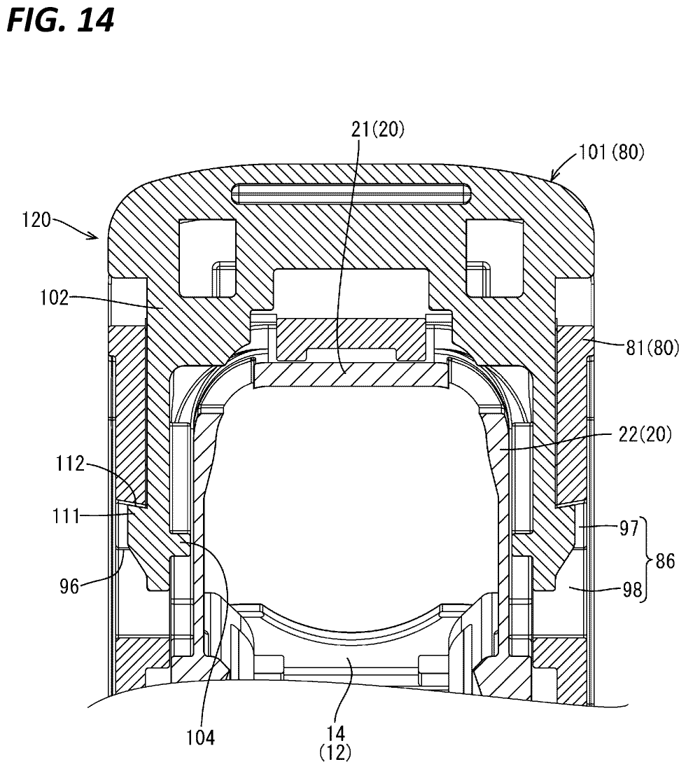

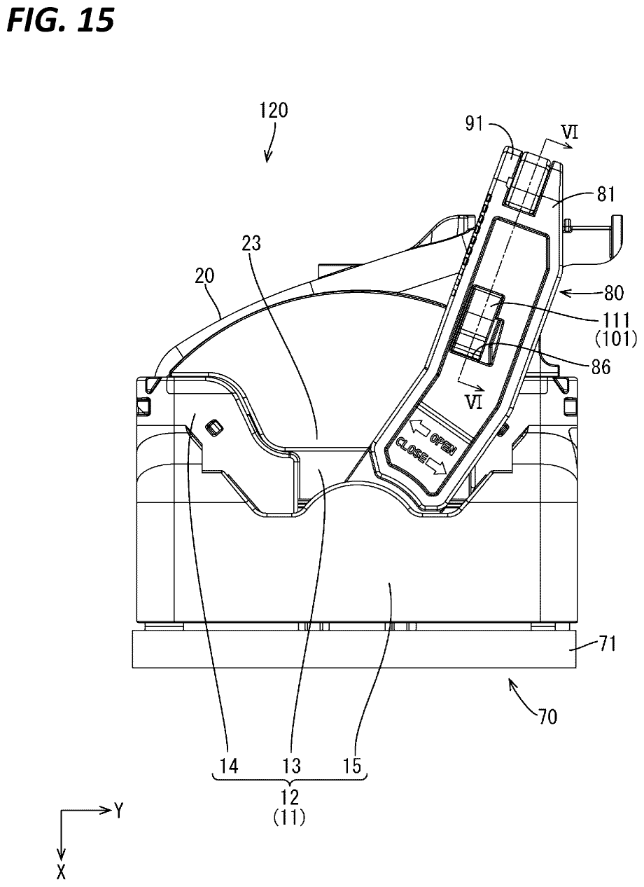

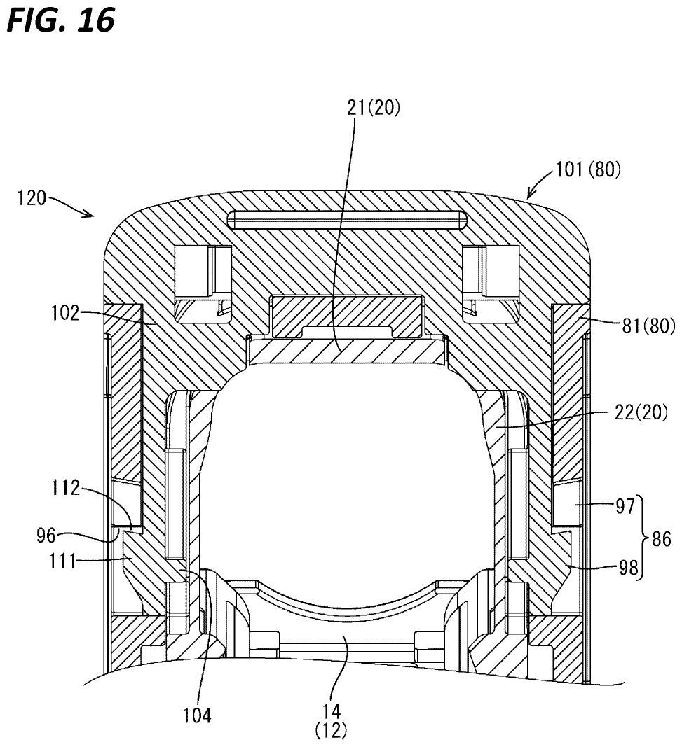

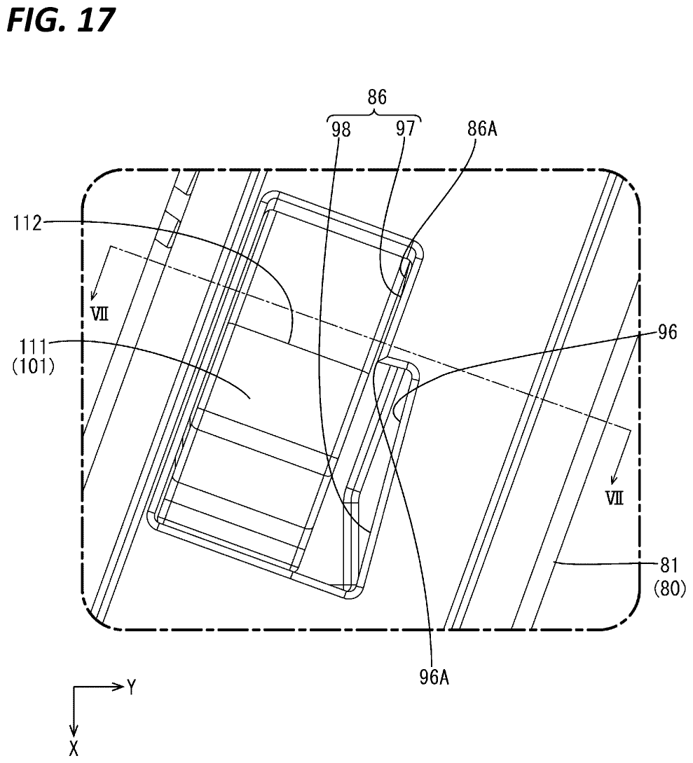

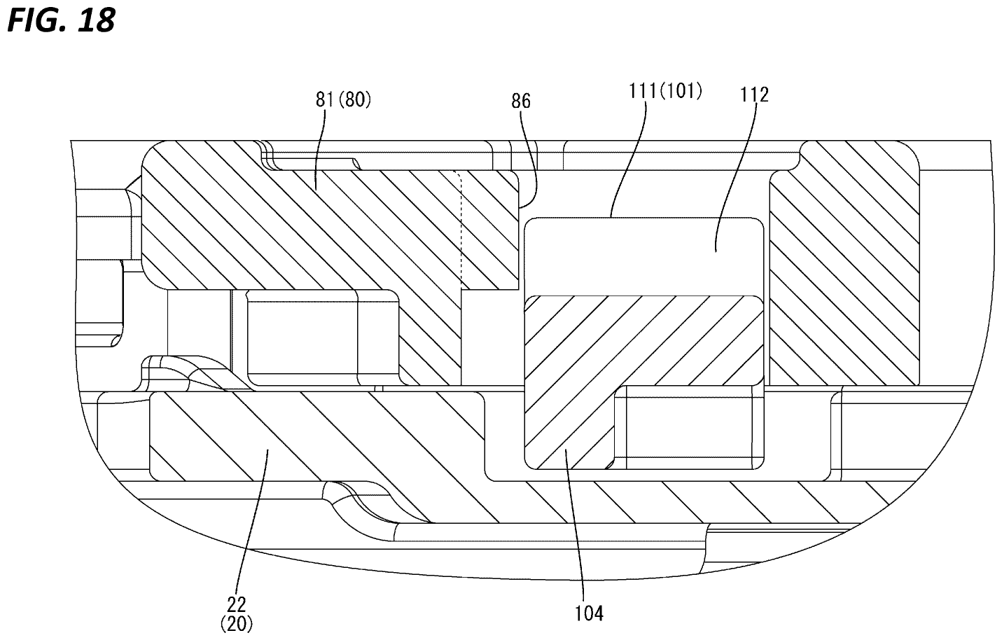

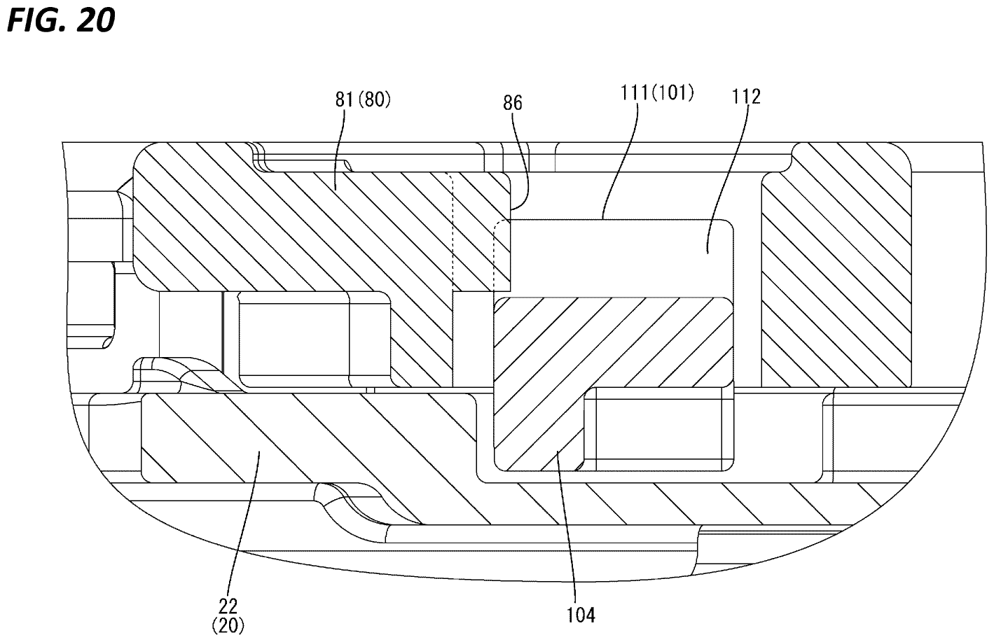

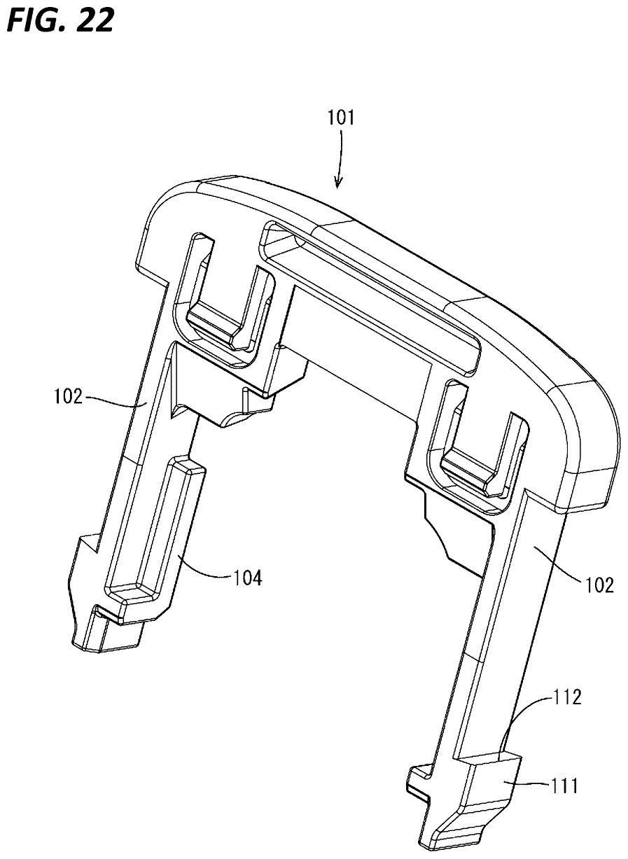

Next, a second embodiment is described using FIGS. 12 to 22. Note that only a configuration different from the first embodiment is described below and components similar to those of the first embodiment are denoted by the same reference signs and repeated description is omitted.

A female connector 120 (an example of the lever-type connector) of this embodiment differs from that of the first embodiment in locking structures (structures of the movement restricting portions) of a lever body 81 and a connection detecting member 101 when the connection detecting member 101 is set in an inclined posture with respect to a lever body 81. Specifically, the locking structure of a projecting portion 111 to a window portion 86 is different from that of the first embodiment.

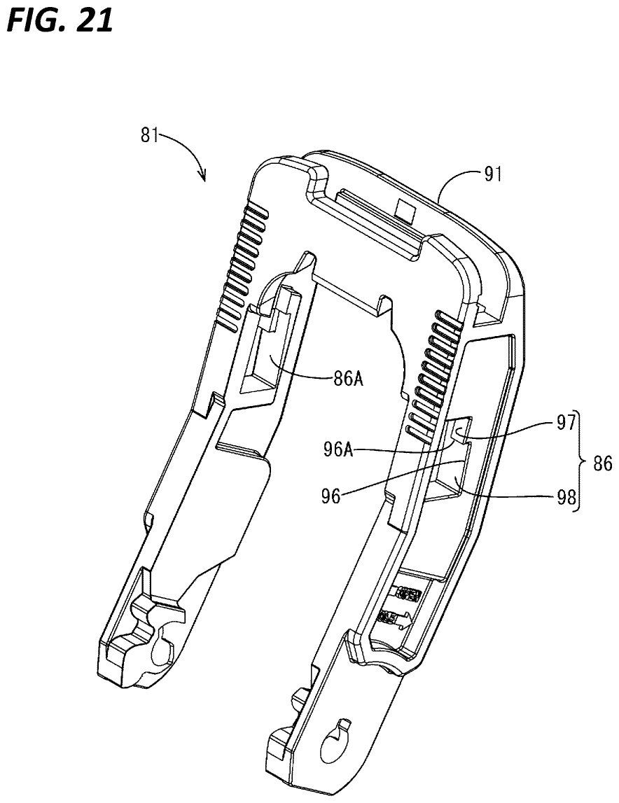

The window portion 86 of the lever body 81 of this embodiment is formed by concavely cutting a tip side (end side opposite to a rotating portion 91) of a connection completion side wall surface 86A, out of the inner peripheral surface of the rectangular window portion 86 while obliquely expanding the window portion 86 in diameter toward the tip side as shown in FIG. 21. An opening of this cut portion 96 is set at a position, where a rising portion 112 of the projecting portion 111 disposed at a detection position can enter the cut portion 96, on the connection completion side wall surface 86A of the window portion 86. That is, the cut portion 96 is provided in a region corresponding to the projecting portion 111 disposed at the detection position. In the following description, a part of the window portion 86 located on the side of the rotating portion 91 is referred to as a narrow portion 97, and a part thereof located on the tip side and formed to be relatively wider than the narrow portion 97 by the cut portion 96 is referred to as a wide portion 98.

A width of a detecting member side arm portion 102 of the connection detecting member 101 of this embodiment is substantially equal to that of the narrow portion 97 of the window portion 86 as a whole. That is, the width of the detecting member side arm portion 102 is smaller than that of the wide portion 98. Further, as in the first embodiment, an L-shaped and projecting guide portion 104 is provided on the inner surface of the detecting member side arm portion 102.

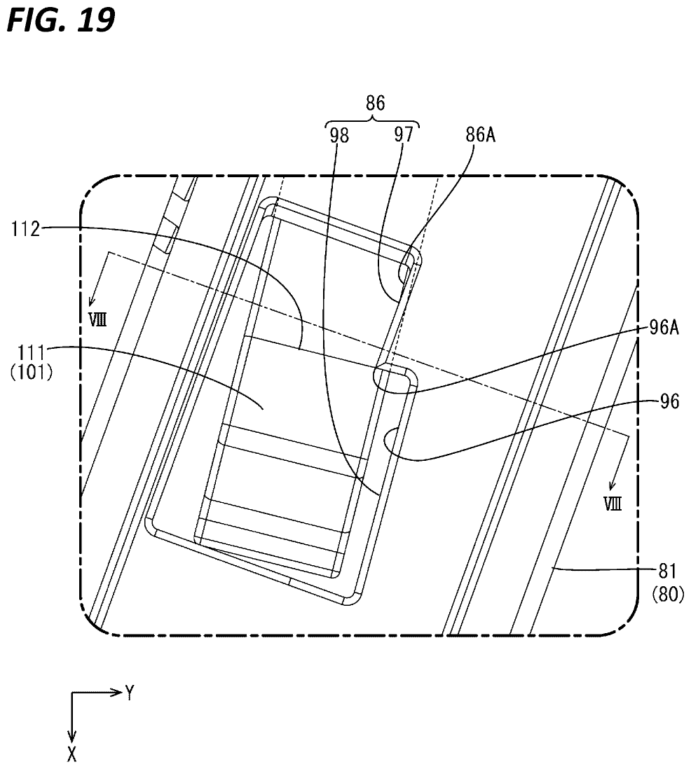

In the female connector 120 of this embodiment, a force may be applied to a lever 80 in a direction to release connection with the connection detecting member 101 disposed at the detection position and the posture of the connection detecting member 101 with respect to the lever body 81 may be set to an inclined posture inclined from a proper posture. Specifically, the posture of the projecting portion 111 with respect to the window portion 86 may be inclined as shown in FIG. 19.

However, in this embodiment, if the posture of the connection detecting member 101 with respect to the lever body 81 is inclined, a part of the projecting portion 111 is fit into the cut portion 96 while being inclined, and the rising portion 112 of the projecting portion 111 is locked to a boundary part between the narrow portion 97 and the wide portion 98, i.e. an opening edge part 96A of the cut portion 96. Therefore, even if a force acts on the connection detecting member 101 in a direction to displace the connection detecting member 101 toward a standby position, the connection detecting member 101 is restricted from moving from the detection position toward the standby position by locking structures (an example of the movement restricting portions) of the projecting portions 111 and the opening edge parts (boundary parts between the narrow portions 97 and the wide portions 98) 96A of the cut portions 96, whereby unintended connection release is suppressed.

As just described, according to the female connector 120 of this embodiment, the cut portion 96 recessed from the connection completion side wall surface 86A and capable of receiving a part of the projecting portion 111 in the inclined posture is provided in a region corresponding to the projecting portion 111 disposed at the detection position, out of the connection completion side wall surface 86A of the window portion 86, whereby a region (wall surface of the narrow portion 97) except the cut portion 96 projects into the window portion 86. By locking the connection detecting member 101 in the inclined posture to the opening edge parts (boundary parts between the narrow portions 97 and the wide portions 98) 96A of the cut portions 96, a displacement toward the standby position can be restricted.

Further, as in the first embodiment, the lever 80 of this embodiment is configured such that the projecting portions 111 and the opening edge parts 96A of the cut portions 96 do not interfere if the connection detecting member 101 is set in the proper posture with respect to the lever body 81, and are locked to each other to restrict relative displacements only when the connection detecting member 101 is set in an inclined posture.

Further, according to this embodiment, since only the lever body 81 needs to be changed to include the cut portions 96 in the window portions 86 while the conventional connection detecting member 101 is used, production cost is excellent.

### Other Embodiments

The present disclosure is not limited to the above described and illustrated embodiments. For example, the following embodiments are also included in the technical scope.

(1) Although the movement restricting portion is provided on the inner surface on the connection completion position side, out of the inner peripheral surface of the window portion, in the above embodiments, a movement restricting portion having a similar configuration can be provided also on the inner surface on the connection start position side.

(2) Although the connection detecting member 51 is restricted from being displaced toward the standby position by locking the ridge portions 37 into the locking recesses 67 of the projecting portions 61 in the inclined posture in the first embodiment, the ridge portions can be, for example, directly locked to the rising surfaces of the projecting portions.

(3) Although the projecting portion 61 of the connection detecting member 51 projects in the rising direction from the plate surface of the detecting member side arm portion 52 in the embodiment, the projecting portion may project in a direction along the plate surface of the detecting member side arm portion and be locked to a locking portion provided on the arm portion.

### LIST OF REFERENCE NUMERALS

10, 120: female connector (lever-type connector)
11 housing body (connector housing)
12: outer housing
13: inner holding wall
14: cover holding wall
15: lever holding wall
16: rotary shaft
17: retaining projection
20: wire cover (connector housing)
21: main wall
22: side wall
23: extended wall portion
24: resilient locking piece
25: arcuate portion
26: escape recess
30, 80: lever
31, 81: lever body
32: arm portion
33: shaft hole
34: passage recess
35: gear portion
35A: first gear tooth
35B: second gear tooth
36, 86: window portion
36A, 86A: connection complete side wall surface
37: ridge portion (locking portion, movement restricting portion)
38: slide guiding portion
41, 91: rotating portion
42: first bridge portion
43: second bridge portion
44: third bridge portion
45: detecting member accommodating portion
51, 101: connection detecting member
52, 102: detecting member side arm portion (body portion)
53: push-in portion
54, 104: guide portion
55: guide body portion
56: contact portion
61, 111: projecting portion
62, 112: rising portion
63 parallel portion
64: inclined portion
65: cut portion
66: rail portion
67 locking recess (movement restricting portion)
70: male connector (mating connector)
71 bottom plate portion
72: receptacle
96 cut portion
96A: opening edge part
97 narrow portion
98: wide portion

1. A lever-type connector, comprising:
a connector housing connectable to a mating connector; and
a lever rotatable from a connection start position to a connection completion position about a rotary shaft provided on a side surface of the connector housing,
the lever including an arm portion disposed along the side surface of the connector housing and a connection detecting member mounted on the arm portion, the connection detecting member being allowed to be displaced from a standby position to a detection position when the lever reaches the connection completion position and being restricted from being displaced from the standby position to the detection position when the lever is at an incomplete connection position without reaching the connection completion position, and
the arm portion and the connection detecting member being provided with movement restricting portions for restricting the connection detecting member in an inclined posture from being displaced toward the standby position by locking each other if the connection detecting member is set in the inclined posture inclined from a proper posture with respect to the arm portion by applying a force to the arm portion in a direction to release connection with the connection detecting member disposed at the detection position and for allowing a displacement of the connection detecting member if the connection detecting member is set in the proper posture.

2. The lever-type connector according to claim 1, wherein:
the arm portion is provided with a window portion penetrating through the arm portion,
the connection detecting member includes a body portion to be disposed along the connector housing and a projecting portion disposed in the window portion by projecting to rise from a plate surface of the body portion, the projecting portion being displaceable between the standby position and the detection position in the window portion,
a locking portion projecting in a direction intersecting a displacement direction of the projecting portion is provided on a connection completion side wall surface disposed at the connection completion position side, out of an inner peripheral surface of the window portion, and
the connection detecting member in the inclined posture is restricted from being displaced toward the standby position by a part of the projecting portion being locked to the locking portion.

3. The lever-type connector according to claim 2, wherein:
the locking portion is ridge-like and provided in a region corresponding to the projecting portion disposed at the detection position, out of the connection completion side wall surface of the window portion,
the projecting portion is provided with a concave locking recess capable of receiving the locking portion when the connection detecting member is set in the inclined posture, and
the connection detecting member in the inclined posture is restricted from being displaced toward the standby position by the locking portion being locked into the locking recess.

4. The lever-type connector according to claim 2, wherein:
a cut portion capable of receiving a part of the projecting portion in the inclined posture by being recessed from the connection completion side wall surface is provided in a region corresponding to the projecting portion disposed at the detection position, out of the connection completion side wall surface of the window portion, and
the connection detecting member in the inclined posture is restricted from being displaced toward the standby position by a part of the projecting portion being locked to an opening edge part of the cut portion.

5. The lever-type connector according to claim 1, wherein an arcuate portion projecting while having an arcuate shape centered on the rotary shaft and capable of holding the connection detecting member at the standby position in a rotation process of the lever and a concave escape recess connected to the arcuate portion and allowing the connection detecting member of the lever disposed at the connection completion position to displaceably escape to the detection position are formed on the side surface of the connector housing.
